(19) United States
(12) Patent Application Publication
(10) Pub. No.: US 2011/0095502 A1
(43) Pub. Date: Apr. 28, 2011

(54) SUSPENSION AND STEERING SYSTEM

(76) Inventor: Winthrop Dada, Ojai, CA (US)

(21) Appl. No.: 12/984,569

(22) Filed: Jan. 4, 2011

Related U.S. Application Data
(63) Continuation-in-part of application No. 12/714,197, filed on Feb. 26, 2010.
(60) Provisional application No. 61/156,226, filed on Feb. 27, 2009.

(51) Int. Cl. B60G 3/26; B62D 3/02

(52) U.S. Cl. 280/124.127

(57) ABSTRACT

The present invention discloses methods and apparatus for controlling dampening in a vehicle with no attributes of wheel scrub and with productive camber change to dial out body roll. The present invention further discloses steering systems, whereas the steering may function without the unwanted attributes of bump steer and roll steer.

### CROSS-REFERENCE TO RELATED APPLICATIONS

This application is a continuation-in-part of U.S. patent application Ser. No. 12/714,197 filed Feb. 26, 2010, now pending, which claims the benefit of U.S. Provisional Application Ser. No. 61/156,226, filed on Feb. 27, 2009, expired, the entire disclosure and contents of which are hereby incorporated by reference.

### FIELD OF THE INVENTION

The present field of the invention relates to vehicle suspension systems and steering systems. More specifically, the present invention relates to a vehicle suspension method and device exhibiting no attributes of wheel scrub and allows for productive management of camber change, throughout compression and rebound of the suspension system. Furthermore, the invention relates to a vehicle steering system operational with the inventive suspension system or independently, wherein the steering system functions without the unwanted attributes of bump steer and deflection steer.

### BACKGROUND

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

Suspension systems for vehicles are well known and comprise a means for attachment of the wheels to the vehicle frame or body and include springs, leafs and/or dampers. The arrangement allows for substantially vertical travel of the wheels while keeping the tire in contact with the ground, thus ensuring maximum tire contact, leading to greater grip and control of the vehicle. Various methods and devices have been used to allow independent movement of each wheel in the vertical plane while retaining maximum tire contact with the road when negotiating bumps and corners. Suspension systems have also evolved to maintain better control of displacement around the vertical and horizontal axis, which might adversely affect the handling of a vehicle. A combination of struts, e.g. Macpherson, lower links, torsion bars, double wishbones, radial arms, trailing arms and beam axles are typical well known examples of such suspension systems.

The most prevalent of these well known suspension designs used in four-wheeled vehicles are the “solid beam” or “live axle” paired with transverse leaf springs. These solid beam/live axle designs are attached to longitudinally mounted leaf springs and coil springs. These crude, yet economic, suspension designs are still in use today, primarily in four-wheeled utility vehicles and trucks. Solid beam/live axle designs, regardless of how they are sprung, suffer from several major shortcomings. Amongst these shortcomings are “bump steer,” high “unsprung mass” and poor packaging, as they occupy a considerable amount of space in the vehicle chassis. While solid beam/live axle designs have relatively no wheel scrub and can achieve high levels of wheel travel, they are “dependent” designs, where one side of the suspension innevitably alters camber on the wheel/tire on the opposite side of the suspension when encountering undulations in the road/ground surface. This dependence results in “bump steer” and causes a change in the vector of the wheels/tires. This is especially problematic in live axle front suspensions when cornering. Bump steer alters the course of the vehicle in an unsafe manner. In addition, the high unsprung mass of live axles results in a rough ride and a slow-reacting suspension. Furthermore, the poor packaging characteristics of live axles require that large amounts of room in the chassis be allocated for suspension articulation.

The major shortcomings in solid beam/live axle suspension designs led to the advent of the “independent” suspension system. Although independent suspensions were a major improvement over solid beam/live axle suspension designs, independent suspensions also have notable shortcomings related to tire scrub, and camber and toe change all relating to the fact that the tire and wheel assembly move in an arc as they articulate.

Independent suspension designs began with swing axles and sliding pillar suspension designs and later moved on to more advanced designs including the Macpherson/Chapman struts, upper and lower A-arm suspension designs (a.k.a. short-long arm or double wishbone designs) and multi-link suspension designs. Unfortunately, all of these independent suspension designs suffer from wheel scrub and some degree of undesirable camber change throughout the wheel's articulation, as well as toe changes leading to variations in under-steer and over-steer. Because current independent designs cause a wheel to travel in an arc, the vehicle cannot have a static track-width and/or wheelbase length. The lack of a static track-width causes problems with bump-steer and vehicle stability. Independent suspension designs also have limited amounts of wheel travel making them a poor choice for vehicles that require a high degree of wheel travel (e.g., off-road and military vehicles).

Early swing axle suspension designs suffered from high degrees of wheel scrub and non-productive camber change. Wheel scrub results in high levels of tire wear and negatively affects handling characteristics and non-productive camber change resulted. It may also cause unpredictable handling and severe over-steer or under-steer, depending on steering placement. Sliding pillar designs suffer from high levels of friction, thus resulting in high tire wear, increased tire heat, poor rebound performance and a relatively rough ride.

Later came the Macpherson/Chapman Strut designs which represented a seminal design change in independent suspensions, and worked relatively well and had good packaging. Wheel scrub and bump-steer remained unresolved problems with the Macpherson/Chapman strut design as did issues with camber change and limited wheel/tire travel. Upper and lower A-arm (double wishbone) suspensions feature very limited camber change when designed for short wheel/tire travel (but not in long wheel/tire travel designs) and suffer from severe wheel scrub and track change. In addition, all variants of existing suspension systems also exhibit steering geometry variations contributing to over steer and under steer.

The most recent development in suspension systems are the multi-link designs that have improved upon previous suspension systems by reducing unsprung mass and limiting camber change when designed for short travel applications. However, like other independent suspension designs, multi-link designs suffer from wheel/tire scrub, bump steer, undesirable chamber change and also have inherently low potential for large amounts of wheel travel.

All variants of existing suspension systems exhibit steering geometry variations as a result of wheel scrub/track-change. This contributes to over-steer or under-steer depending on the use of either leading or trailing steering arms. Bump-steer occurs when the wheel travels on a different arc than the steering tie-rod. When the steering is pointed straight ahead the wheel and tie-rod are on the same arc of motion. However this is no longer true when turning through a corner where the tie rod and its arc of motion have moved in or out with relation to the arc of the wheel/tire.

The increased level in performance of modern vehicles and tires has magnified the shortcomings of existing suspension systems, and in certain applications, has become the major hurdle in achieving better performance. For example, in off-road racing applications, the high degree of travel in the suspension system leads to various changes in suspension geometry, in turn leading to changes in track width, camber, castor, and toe. These variations limit the degree of certainty engineers may rely upon in developing suspension systems for better traction and performance. In the most popular Macpherson/Chapman strut applications, as the wheel and tire combination at the front of a four-wheeled vehicle rebounds, load is relieved on the particular wheel/tire and the wheel/tire geometry travels towards positive camber. The wheel also travels in an arc, increasing tire scrub and depending on the steering mechanism, leading to either over-steer or under-steer. As load is reestablished on the wheel/tire combination and the suspension system is compressed, the suspension geometry forces the wheel/tire to change from positive camber to neutral and then to negative camber. The arc of motion once again leads to large degrees of tire scrub and alters steering geometry by increasing and/or decreasing under-steer or over-steer. Accordingly, articulation of the suspension system leads to variations in the contact patch and directional vector of the tire/wheel, creating handling difficulties for a driver trying to keep the vehicle in control. In order to compensate for certain handling issues relating to camber during cornering, wheels are commonly set to negative camber, so that the wheel is in an improved position when encountering forces associated with cornering, which will naturally alter camber. While setting the wheels to slightly negative camber may improve certain aspects of performance with respect to the leading (outside) wheel while cornering (when applied to conventional suspension systems), the opposite (inside) wheel necessarily assumes an unfavorable position, simultaneously, leading to significant inefficiencies in handling, wheel wear and gas mileage.

Given the numerous inefficiencies inherent in many modern suspension mechanisms, there are substantial advantages to a suspension system that is capable of productively controlling wheel camber to dial out body roll, while eliminating tire scrub and/or toe, as well as track-change and bump-steer. There are also advantages in providing a suspension system capable of controlling and varying camber change according to pre-determined settings. Further advantages are gained by providing a method for controlling articulation of a suspension system capable of setting desired rates for camber, castor, tire scrub, and toe such that the desired rates remain consistent throughout the articulation realm of the suspension system. These novel attributes of the invention provide for improvements in tire-wear, handling, gas mileage and overall performance.

The present invention describes articulating arm suspension designs and methods of use thereof that resolve existing impediments in suspension geometry. The articulating arm suspension designs may be adapted to provide various amounts of wheel travel, while offering fully independent operation, relatively low unsprung mass and compact packaging. The articulating arm suspension designs in conjunction with a camber-link element overcome the shortcomings of prior independent suspension designs by completely eliminating wheel scrub and bump steer, while productively managing camber change to “dial out” body roll. Also, unlike other independent designs, large amounts of wheel travel can be incorporated into the design if desired, while maintaining a very compact overall package.

### SUMMARY OF THE INVENTION

The following embodiments and aspects thereof are described and illustrated in conjunction with compositions and methods which are meant to be exemplary and illustrative, not limiting in scope.

In certain embodiments the invention teaches an apparatus, including a first articulating arm including a first upper arm having an inferior end and a superior end and a first lower arm having an inferior end and a superior end, wherein the inferior end of the first upper arm is pivotally attached to the superior end of the first lower arm; a second articulating arm including a second upper arm having an inferior end and a superior end and a second lower arm having an inferior end and a superior end, wherein the inferior end of the second upper arm is pivotally attached to the superior end of the second lower arm; a wheel carrier pivotally attached to the inferior ends of the first and second lower arms; a steering knuckle having a superior end and an inferior end, wherein the steering knuckle is attached to the wheel carrier; a camber-link arm having a superior end and an inferior end, wherein the camber-link arm is pivotally attached at its superior end to the superior end of the steering knuckle and is pivotally attached at its inferior end to the inferior end of the first lower arm.

In certain embodiments, the inferior end of the camber-link arm and the inferior end of the first articulating arm are each independently configured to be attached to one another at any one of multiple points of attachment thereupon.

In certain embodiments, the first and second articulating arms are each independently capable of articulating to form an angle of from about 0 degrees to about 180 degrees, as measured between the upper and lower arms of each articulating arm, respectively.

In certain embodiments, the first and second articulating arms, when articulated to an angle of 180 degrees, are each configured in a plane substantially parallel to the vertical axis of the wheel carrier.

In certain embodiments, the invention includes at least one removable dampener for controlling articulation of the first and second articulating arms.

In certain embodiments the at least one dampener is selected from the group consisting of a shock, a spring, a leaf spring, a coil, a torsion bar, a cantilever spring, a cantilever shock and combinations thereof.

In certain embodiments the invention includes an adjustable vertical limiter affixed substantially perpendicular to the wheel carrier for regulating suspension travel.

In certain embodiments the invention includes the chassis of a vehicle, pivotally attached to the superior ends of the first and second upper arms.

In certain embodiments the first articulating arm is attached to a first side of the wheel carrier and the second articulating arm is attached to an adjacent second side of the wheel carrier such that the apex of each of the articulating arms points in the opposite direction from the center of the wheel carrier when the articulating arms articulate to form an angle of less than 180 degrees.

In certain embodiments the invention teaches an apparatus, including: a first articulating arm includes a first upper arm having an inferior end and a superior end and a first lower arm having an inferior end and a superior end; a second articulating arm comprising a second upper arm having an inferior end and a superior end and a second lower arm having an inferior end and a superior end, a wheel carrier attached to the first and second articulating arms, a steering knuckle having a superior end and an inferior end, wherein the steering knuckle is attached to the wheel carrier, a camber-link arm having an inferior end and a superior end, the superior end of the camber-link arm is pivotally attached to the superior end of the steering knuckle, wherein the inferior end of the first upper arm is pivotally attached to the superior end of the first lower arm forming a first articulating arm, the inferior end of the second upper arm is pivotally attached to the superior end of the second lower arm, forming a second articulating arm, and the inferior ends of the first and second lower arms are pivotally attached to the wheel carrier, and the superior end of the camber-link arm is pivotally attached to the superior end of the steering knuckle, and the inferior end of the camber-link arm is pivotally attached to the inferior end of the first articulating arm, a steering mechanism, means for the steering mechanism to mechanically communicate with the inferior end of the camber-link arm, whereby the camber-link arm is configured to follow an arc-shaped path upon actuation resulting from steering input, to thereby effectuate camber.

In certain embodiments, the invention includes: a camber-link-arc element, including first and second opposing sides, a back, a superior end and an inferior end, wherein the first and second sides each include an arc-shaped channel substantially along their respective vertical axes such that the arc-shaped channels are mirror images of one another, and the arc shape and direction of each channel is configured to approximate the path travelled by the inferior end of the camber-link arm when it is actuated, and wherein the back of the camber-link-arc element is affixed to the inferior end of the first articulating arm; a rod extending across the camber-link arc element from the channel of the first side to the channel of the second side, wherein the rod is attached to the inferior end of the camber-link arm; and means for the steering mechanism to mechanically communicate with the rod.

In certain embodiments, the steering mechanism to mechanically communicate with the inferior end of the camber-link arm includes: a steering cam in communication with a rocker arm, the rocker arm including: a superior end and an inferior end, the superior end of the rocker arm comprising a rolling element on a first side that interacts with the steering cam, means for the rocker arm to pivot along a central axis perpendicular to its length upon interaction with the steering cam, a hole through the inferior end of the rocker arm and oriented perpendicular to the axis of rotation of the rolling element, a cable traversing the hole in the rocker arm, the cable having a superior end and an inferior end, the superior end anchored to the inferior end of the first side of the rocker arm such that it is prevented from entering the hole in the rocker arm through which the cable proceeds, a cable housing with a superior end and an inferior end, the cable housing surrounding the portion of the cable extending beyond a second side of the inferior end of the rocker arm, a brace located between the superior end of the cable housing and the second side of the inferior end of the rocker arm, the brace including a hole aligned with the hole in the inferior end of the rocker arm, through which the cable passes; a plate with a superior side and an inferior side, the plate includes a hole through which the cable passes, the superior side of the plate is in communication with the inferior end of the cable housing; a spring with a superior end and an inferior end, the superior end of the spring in communication with the inferior side of the plate, the spring surrounding the portion of cable extending beyond the inferior side of the plate and the cable housing; the rod comprising a hole in its short axis, the rod in communication with the inferior end of the spring and extending across the diameter of the inferior end of the spring, the cable passing through the hole in the rod from a superior aspect of the rod to the inferior aspect of the rod; the cable anchored to the inferior aspect of the rod, the rod attached to the inferior end of the camber-link arm, wherein the spring is substantially housed within the camber-link element, and the rod extends from the first arc-shaped channel across the inferior end of the spring and into the second arc-shaped channel, and the back of the camber-link-arc element is attached to the inferior end of the first articulating arm.

In other embodiments, the invention teaches a method of inducing camber change by rotating the steering cam, causing the cable to extract out of the cable housing, thereby causing the rod and the inferior end of the camber-link arm attached thereto to move along the arc-shaped channel, thereby inducing camber change.

In certain embodiments, the invention further includes means for attaching the camber-link-arc element at various angles to the inferior end of the first articulating arm.

In certain embodiments, the means for attaching the camber-link arc element includes a ride height arm with a first end and a second end; the first and second ends comprising holes, wherein the first end is attached to the superior end of the camber-link arc element and the second end is attached to the inferior end of the first articulating arm, and wherein the inferior of end of the camber-link arc element is attached to the first articulating arm at a position closer to the wheel carriage than the second end of the ride height arm.

In certain embodiments, the invention further includes a dampener.

In certain embodiments, the dampener is selected from the group consisting of a shock, a spring, a leaf spring, a coil, a torsion bar, a cantilever shock, a cantilever spring and combinations thereof.

In certain embodiments, the invention teaches a chassis pivotally attached to the superior ends of the first and second arms.

In certain embodiments the invention teaches an adjustable vertical limiter affixed substantially perpendicular to the wheel carrier for regulating suspension travel.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 depicts a front quarter perspective view of a partially compressed articulating arm suspension system in accordance with an embodiment of the present invention.

FIG. 2 depicts a back quarter perspective view of a partially rebounded articulating arm suspension system in accordance with an embodiment of the present invention.

FIG. 3 depicts a front perspective view of an approximately quarter-compressed articulating arm suspension system in accordance with an embodiment of the present invention.

FIG. 4 depicts a front perspective view of an approximately half compressed articulating arm suspension system in accordance with an embodiment of the present invention.

FIG. 5 depicts a front perspective view of an approximately three quarter-compressed articulating arm suspension system in accordance with an embodiment of the present invention.

FIG. 6 depicts a ride-height arm in accordance with an embodiment of the present invention.

FIG. 7 depicts an exploded view of a camber-link arc element, as well as a spring and rod that function in connection with the element in accordance with an embodiment of the present invention.

FIG. 8 depicts a camber-link arc element with the rod resting in the bottom of the side arc-shaped channels of the element in accordance with an embodiment of the present invention.

FIG. 9 depicts a camber-link arc element with a rod compressing the spring as the cable is drawn upward and the rod is positioned near the top of the arc-shaped channels in the element in accordance with an embodiment of the present invention.

FIG. 10 depicts an exposed perspective view of a steering system in communication with the arc-shaped channel in accordance with an embodiment of the present invention.

FIG. 11 depicts a front perspective view of an approximately quarter compressed articulating arm suspension system in which the steering knuckle is set to zero camber and the inferior end of the camber-link arm is resting in the bottom of the channel of the camber-link arc element in accordance with an embodiment of the present invention.

FIG. 12 depicts a front perspective view of an approximately half compressed articulating arm suspension system in which the steering knuckle is set to zero camber and the inferior end of the camber-link arm is resting in the bottom of the channel of the camber-link arc element in accordance with an embodiment of the present invention.

FIG. 13 depicts a front perspective view of an approximately three quarter compressed articulating arm suspension system in which the steering knuckle is set to zero camber and the inferior end of the camber-link arm is resting in the bottom of the channel of the camber-link arc element in accordance with an embodiment of the present invention.

FIG. 14 depicts a front perspective view of an approximately quarter compressed articulating arm suspension system in which the steering knuckle is in a position resulting in positive camber as the inferior end of the camber-link arm is positioned in the upper part of the channel of the camber-link arc element in accordance with an embodiment of the present invention.

FIG. 15 depicts a front perspective view of an approximately half compressed articulating arm suspension system in which the steering knuckle is in a position resulting in zero camber as the inferior end of the camber-link arm is positioned in the upper part of the channel of the camber-link arc element in accordance with an embodiment of the present invention.

FIG. 16 depicts a front perspective view of an approximately fully compressed articulating arm suspension system in which the steering knuckle is in a position resulting in negative camber as the inferior end of the camber-link arm is positioned in the upper part of the channel of the camber-link arc element in accordance with an embodiment of the present invention.

FIG. 17 depicts a front perspective view of an approximately quarter compressed articulating arm suspension system in which the steering knuckle is in a position resulting in positive camber in accordance with an embodiment of the present invention.

FIG. 18 depicts a front perspective view of an approximately half compressed articulating arm suspension system in which the steering knuckle is in a position resulting in zero camber in accordance with an embodiment of the present invention.

FIG. 19 depicts a front perspective view of an approximately fully compressed articulating arm suspension system in which the steering knuckle is in a position resulting in negative camber in accordance with an embodiment of the present invention.

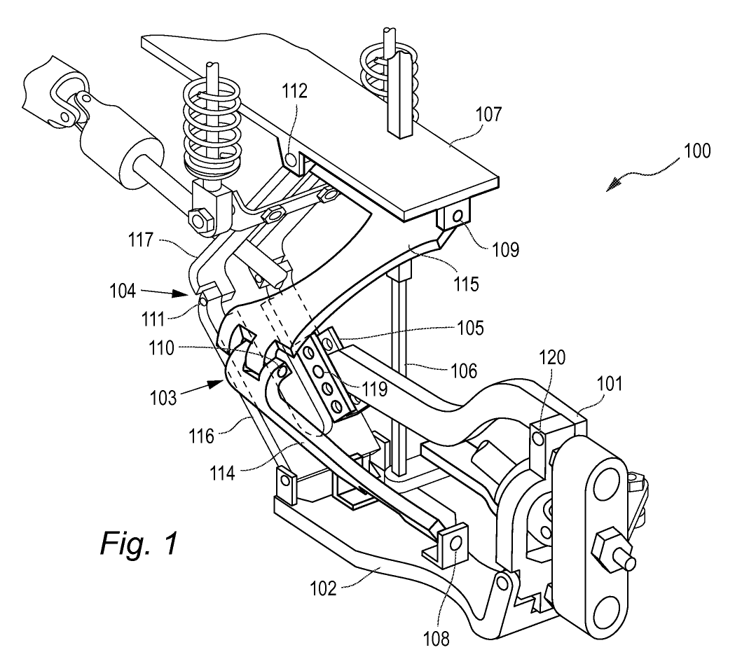

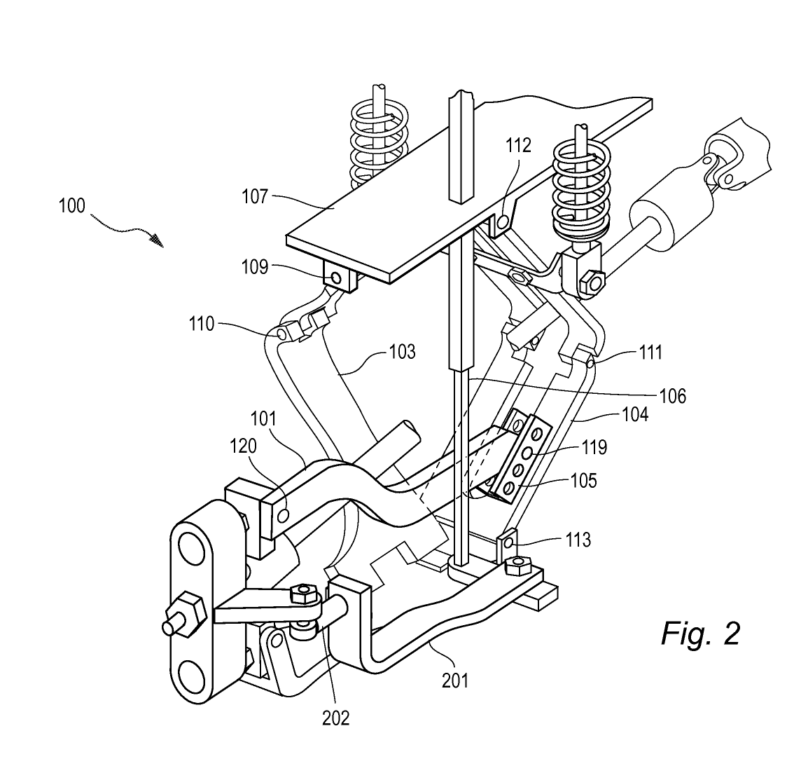

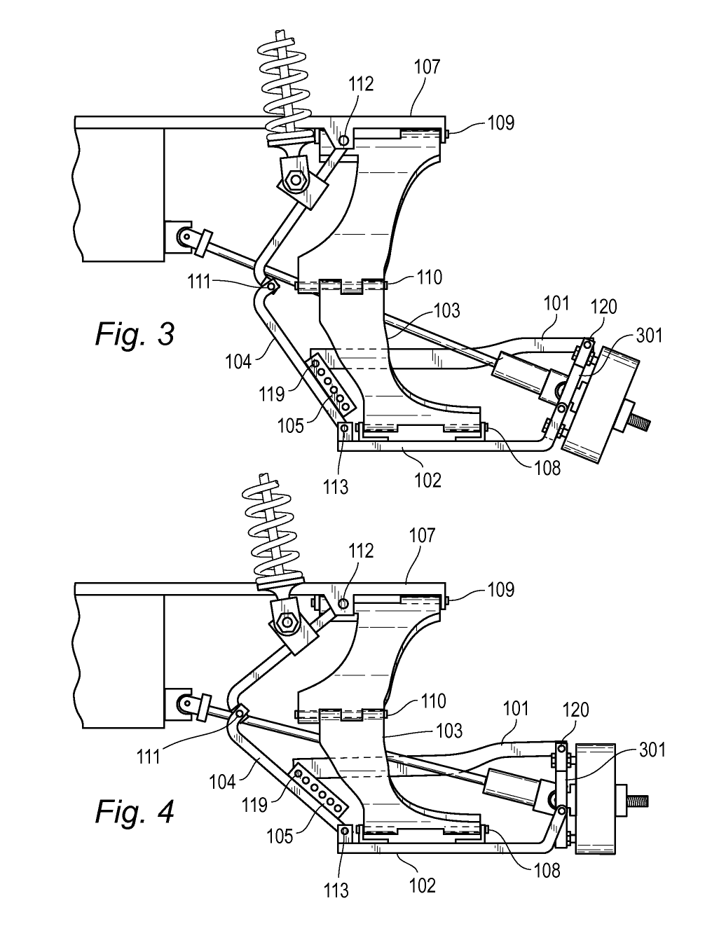

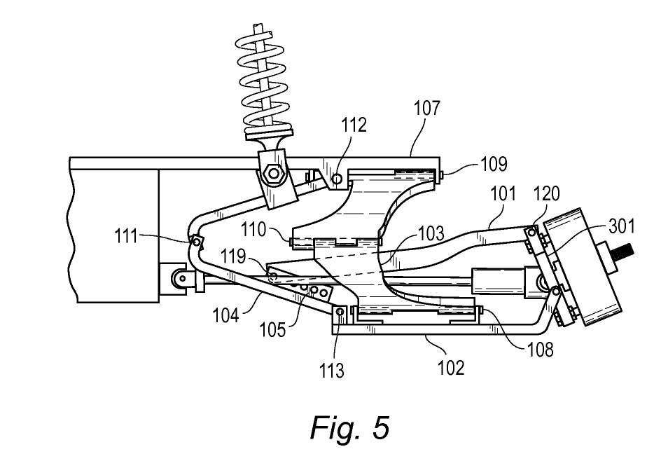

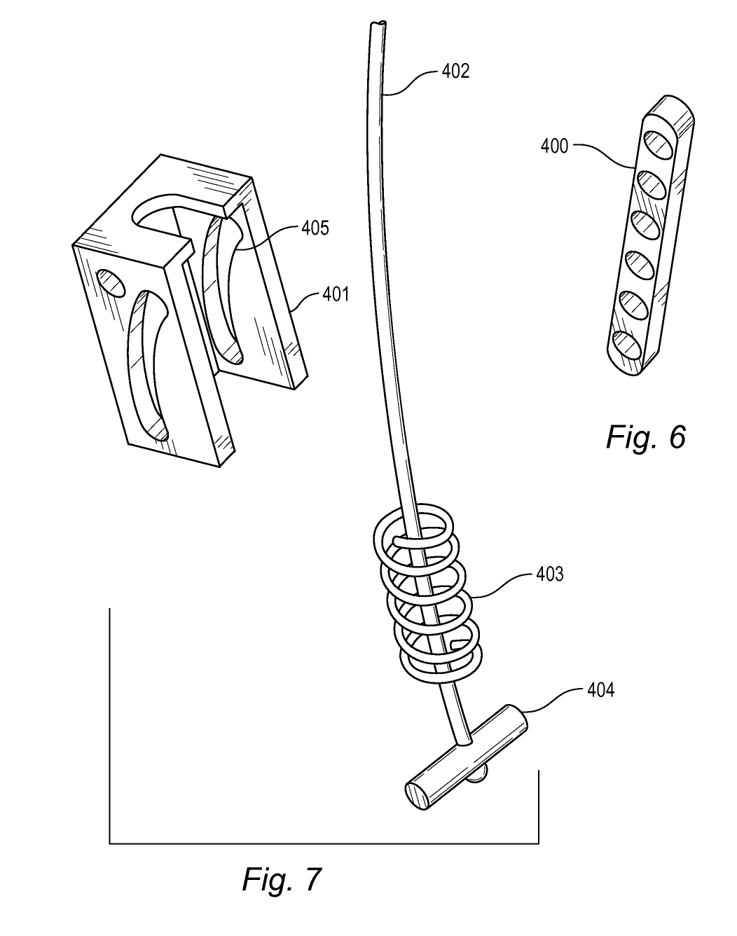

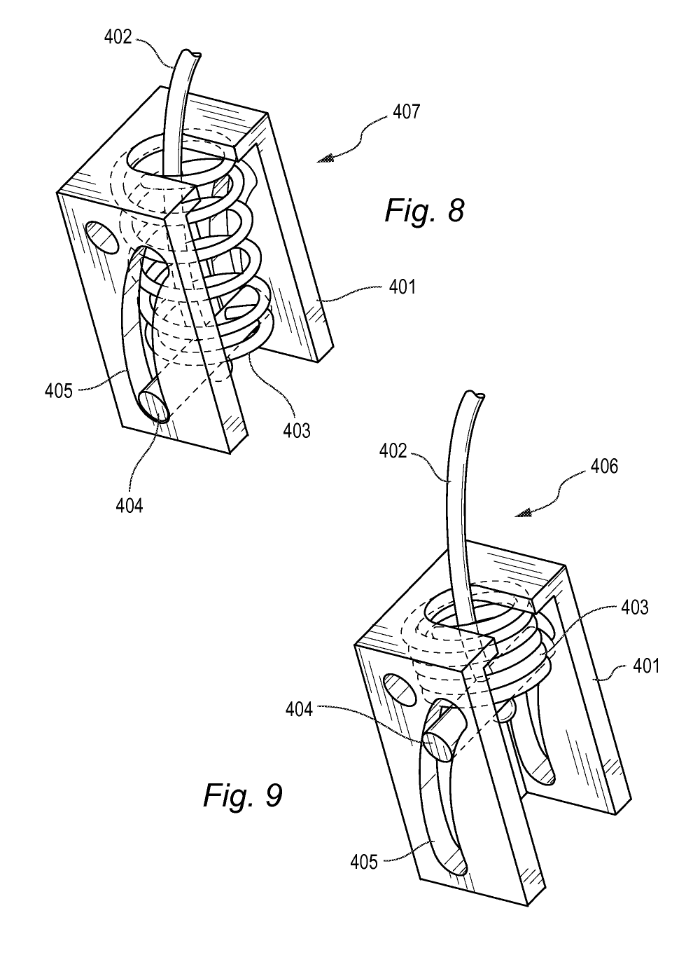

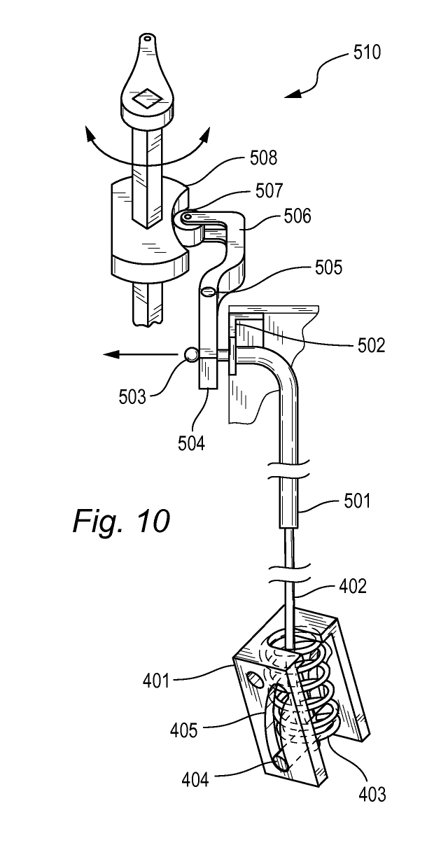

### DESCRIPTION OF THE INVENTION

All references cited herein are incorporated by reference in their entirety as though fully set forth. Unless defined otherwise, technical terms used herein have the same meaning as commonly understood by one of ordinary skill in the art to which this invention belongs. Competition Car Suspension: A practical handbook, Staniforth, Allan (2006); Chassis Engineering HP 1055, Adams, Herb (1993); and Chassis and Suspension Handbook, Munroe, Carl (2003) provide one skilled in the art with a general guide to many of the terms used in the present application.

One skilled in the art will recognize many methods and materials similar or equivalent to those described herein, which could be used in the practice of the present invention. Indeed, the present invention is in no way limited to the methods and materials described. For purposes of the present invention, the following terms are defined below.

“Bump Steer” as used herein refers to the tendency of corresponding wheels to steer (inwards or outwards) as the wheels move upwards and downwards during suspension travel.

“Camber” as used herein refers to the angle made by the wheel of an automobile; specifically, it is the angle between the vertical axis of the wheel and the vertical axis of the vehicle when viewed from the front or rear. Camber is used in the design of steering and suspension. If the top of the wheel is farther out than the bottom (that is, away from the axle), it is in positive camber; if the bottom of the wheel is farther out than the top, it is in negative camber.

“Compression” as used herein refers to the constriction of the vehicle suspension system, for example, as the result of encountering a bump.

“Contact Patch” as used herein refers to the portion of a vehicle's tire that is in actual contact with the road surface.

“Rebound” as used herein refers to the expansion of the vehicle suspension system, for example when ‘rebounding’ from hitting a bump.

“Roll/Bump Steer” as used herein refers to the tendency of a wheel to steer (inwards or outwards) as the wheel moves upwards and downwards during suspension travel.

“Steering Axis Inclination” (SAI) as used herein involves the steering axis which is the line between the top pivot point of the hub and the lower ball joint of the hub. On a Macpherson strut, the top pivot point is the strut bearing, and the bottom point is the lower ball joint. On a suspension using upper and lower control arms, the pivot points are where the upright connects to the control arms. The inclination of the steering axis is measured as the angle between the steering axis and the centerline of the wheel.

“Tire Scrub” as used herein refers to the tire scrub radius which is the distance on the ground between the centerline of the tire contact patch and the point at which the SAI intersects the ground. If these two lines intersect at ground level, then zero scrub results. If the SAI intersects the ground at a point inside or outside of the centerline of the contact patch, then positive or negative scrub results, respectively.

“Toe” as used herein refers to the symmetric angle that each wheel makes with the longitudinal axis of the vehicle, as a function of static geometry, and kinematic and compliant effects. For example, if the leading edge of a tire points towards the longitudinal axis of the vehicle, the tire is said to have ‘toe-in,’ whereas if the tire points away from the longitudinal axis of the vehicle, the tire is said to have ‘toe-out.’ The amount of toe can be expressed in degrees as the angle to which the tire deviates from parallel, or more commonly, as the difference between the track width as measured in inches or centimeters. Toe settings affect three major areas of vehicle performance: tire wear, straight-line stability and corner entry handling characteristics.

“Camber-link” as used herein refers to the arm connecting between the steering knuckle and a first articulating arm of the suspension.

“Superior,” as used herein, refers to the end of the element capable of being situated furthest from the ground during its natural range of motion or position, as depicted in the drawings.

“Inferior,” as used herein, refers to the end of the element capable of being situated closest to the ground during its natural range of motion or position, as depicted in the drawings.

The present invention discloses a suspension apparatus (“suspension system”) and method of use thereof that eliminates tire scrub and allows for productive camber control that dials out body roll, throughout the suspension systems' articulation. The present invention further teaches a suspension apparatus capable of eliminating toe changes throughout the suspension systems' articulation. The present invention further discloses a steering mechanism which cooperates with the inventive suspension systems to eliminate tire scrub, actively control variations in camber, and incidents of bump steer and/or roll steer, as the suspension system articulates. The present invention further teaches a suspension system with no camber change when steering straight ahead but with camber change when steering left or right when the suspension is in compression or droop. Application of the present invention may be utilized on all vehicles requiring a dampening method, including but not limited to, automobiles, motorcycles, trucks, office chairs, bicycles, bicycle seats, pogo sticks, and other apparatuses known in the art.

In one embodiment, the present invention teaches a suspension apparatus 100 comprising a first articulating arm 103 and a second articulating arm 104, each articulating arm including an upper arm 115 and 117, respectively and a lower arm 114 and 116, respectively. In each articulating arm, the inferior end of the upper arm is pivotally attached to the superior end of the lower arm by a mid-level pivot point 110 and 111. Each of the two articulating arms are further fitted with pivot points at the superior end of the upper arm 109 and 112 and inferior end of the lower arm 108 and 113. The superior pivot points of the upper arms 109 and 112 are attached to a chassis 107, thus bracing the articulating arm suspension 100. The inferior pivot points of the lower arms 108 and 113 are attached to a wheel carrier 102. The wheel carrier 102 is in communication with the vehicle's wheel/tire assembly, which travels in a substantially vertical position to the road surface. The superior pivot points 109 and 112, inferior pivot points 108 and 113, and mid-level pivot points 110 and 111 permit for articulation of the articulating arms in a substantially vertical plane, allowing the articulating arm suspension to compress and rebound.

In one embodiment, the at least two articulating arms are each capable of articulating to form an angle of nearly 0 degrees, when fully “closed” and nearly 180 degrees, when fully open. In each case, the angle is measured between the upper arms 115 and 117 and lower arms 114 and 116 of each articulating arm, respectively.

In one embodiment, the two articulating arms are situated on adjacent sides of the wheel carrier. In certain embodiments, at least one of the two articulating arms is attached to the wheel carrier 102.

In another embodiment, the present invention teaches an articulating arm suspension system, wherein the upper arm and lower arm are of equal length. In yet another embodiment, the present invention teaches an articulating arm suspension system wherein the upper arm and lower arm are of unequal length.

In another embodiment, the present invention further teaches a camber-link arm 101 connecting the top of the steering knuckle 301 and to the inferior portion of the first articulating arm 104 in the suspension system. In yet another embodiment, the steering knuckle 301 is mounted on a pivot point and results in negative camber or positive camber when loaded or unloaded, respectively. In another embodiment, this configuration allows for the “dial out” of body roll, such that wheel position due to camber diminishes or eliminates body roll. In another embodiment the camber-link arm 101 has holes on one or more of each of its ends of attachment in order to allow for variable points of attachment, and therefore varying “effective lengths.” One of skill in the art would readily appreciate there are many ways to attach the camber-link arm 101 to the first articulating arm 104. In one embodiment, the camber-link arm 101 is pivotally attached 119 to the first inferior arm of the first articulating arm with a bracket 105. In another embodiment, the bracket has two parallel sides and a back. In certain embodiments the two parallel sides of the bracket have holes that allow for attachment of the camber-link arm with a pin that extends from one side of the bracket, through the camber-link arm and into the next side of the bracket. In certain embodiments the rate of camber change and amount of camber change in response to suspension compression or relaxation can by altered by varying the “effective length” of said camber-link arm as determined by the placement of the pivot point on the first articulating arm 119, and the distance from that pivot point 119 to the superior end of the steering knuckle 120. In certain embodiments, as the point of attachment of the camber-link arm moves up the first articulating arm, more camber change results. In certain embodiments, when the camber-link arm is attached to point of the first articulating arm coincident with the wheel carriage, camber is set at zero.

In certain embodiments of the invention, the camber-link arm is attached to the first articulating arm 104 using a camber-link-arc element 401. In one embodiment camber-link arc element 401 includes two opposing and parallel sides, a back, a superior end and an inferior end, wherein the first and second sides each include an arc-shaped channel 405 along their respective vertical axes such that the arc-shaped channels are mirror images of one another. In certain embodiments, the arc shape and the direction of each channel 405 approximates the path travelled by the inferior end of the camber-link arm 101 when it is actuated. In other embodiments, the shape of the channels 405 are designed to be different in shape than the natural arc-shaped path of the inferior part of the camber-link arm 101, in order to account for sidewall deflection. One of skill in the art would readily appreciate that the shape of the “camber-link-arc” could be designed to account for desirable handling characteristics under various conditions. In some embodiments, the camber-link arc element 401 is designed to house a spring 403. In certain embodiments, the top of the spring is in contact with the top of the camber-link arc element 401 and the bottom of the spring is in contact with a rod 404 that extends across the bottom of the spring 403 and into each channel 405 of the camber-link-arc element. In certain embodiments, the rod 404 is pivotally attached to the camber-link arm 101. In certain embodiments, the rod 404 is attached to a cable 402 that is further connected to a steering mechanism 510. In certain embodiments, the steering mechanism 510 actuates camber by drawing the rod 404 against the spring 403 in response to steering off center, thereby causing the inferior end of the camber-link arm 101 to rise vertically along an approximately arc-shaped path. In some embodiments, the steering mechanism includes a steering pillar with a steering cam 508 in communication with a rocker arm 506. In certain embodiments, the rocker arm 506 has a superior end and an inferior end. In certain embodiments a first side of the superior end includes a roller element 507 that interacts with the steering cam 508. In another embodiment, the rocker arm 506 contains a pivot point along its short axis 505. In some embodiments, the rocker arm 506 is pivotally attached to a flat chassis bar at its pivot point. In certain embodiments, the attachment point is adjacent to where the chassis bar meets the steering pillar. In certain embodiments the inferior end of the rocker arm 506 includes a hole perpendicular to the axis of rotation of the rotating element. In some embodiments, the superior end of a cable 503 is attached to the inferior end of the first side of the rocker arm 506 and passes through the hole therein and exits on a second side of the rocker arm, parallel to the first side. In some embodiments, cable housing 501 surrounds the portion of cable extending beyond the second side of the rocker arm 506. In certain embodiments, a brace 502 is located between the superior end of the cable housing 501 and the rocker arm 506. In certain embodiments, the brace 502 includes a hole in alignment with the hole in the rocker arm 506, such that the cable 402 proceeds through the brace 502. In some embodiments the diameter of the cable housing 501 is greater than the diameter of the hole in the brace, such that the cable housing 501 cannot retract into the hole in the brace. In certain embodiments, the inferior end of the cable housing 501 communicates with a plate. In some embodiments, the plate has a superior side and an inferior side and a hole aligned with the hole in the cable housing, such that the cable passes through the plate. In some embodiments, the plate is in communication with the superior end of the camber-link-arc element 401. In certain embodiments, the plate is attached to the superior end of the camber-link-arc element. In some embodiments, the cable extends through the spring 403 and through a hole in the superior aspect of the rod 404, and the cable 402 is anchored to an inferior aspect of the rod 404. In certain embodiments, the steering naturally self-centers.

As one of skill in the art would readily appreciate, there are many configurations of and types of steering mechanisms that could be adapted to interact with the camber-link arc element and the camber-link arm. In one embodiment, the cable 402 could be replaced with hydraulic or electric controls.

In certain embodiments, the steering mechanism includes a sliding pillar mechanism 106. In certain embodiments, the camber-link arc element 401 is attached to the inferior end of the first articulating arm 116 using a ride-height arm 400. In certain embodiments the ride-height arm 400 has a superior end and an inferior end. In certain embodiments, the superior end of the ride-height arm 400 attaches to the superior end of the camber-link arc element 401, the inferior end of the ride-height arm 400 attaches to the inferior end of the first articulating arm 116, and the inferior end of the camber-link arc-element attaches to a point lower on the first articulating arm 104 than the inferior end of the ride-height arm 400. In certain embodiments, the points of attachment of the ride-height arm 400 and the camber-link-arc element are selected to result in zero camber when steering straight ahead and/or during neutral suspension compression or droop, and in positive or negative camber when steering off-center while the suspension is in droop or compression.

Another embodiment of the invention includes a method of positioning the camber-link arc element 401 at an angle with respect to the inferior end of the first articulating arm 104 such that the pivot point of the inferior end of the camber-link arm is in approximate alignment with the bottom of the camber-link arc channel 405 when the steering knuckle is set to result in zero camber. In another embodiment of the invention, the ride-height arm 400 is used to position the camber-link arc element 401 at said angle.

In yet another embodiment, the invention steering system may utilize worm gears, captive rollers, ball bearings, lever arms, or other gear arrangement known in the art for operating the steering system. In another embodiment of the invention steering system, operational connectivity of the steering rack, torque tube, tie rod, steering damper and spindle may incorporate the use of angled pinion gears, u-joints, or other mechanisms known in the art for functional operation of the steering system.

In another embodiment, the steering mechanism of the present invention may utilize a slip yoke, springs, leaf springs, pressure damper, or other dampening devices known in the art for steering dampening by the steering damper.

### EXAMPLES

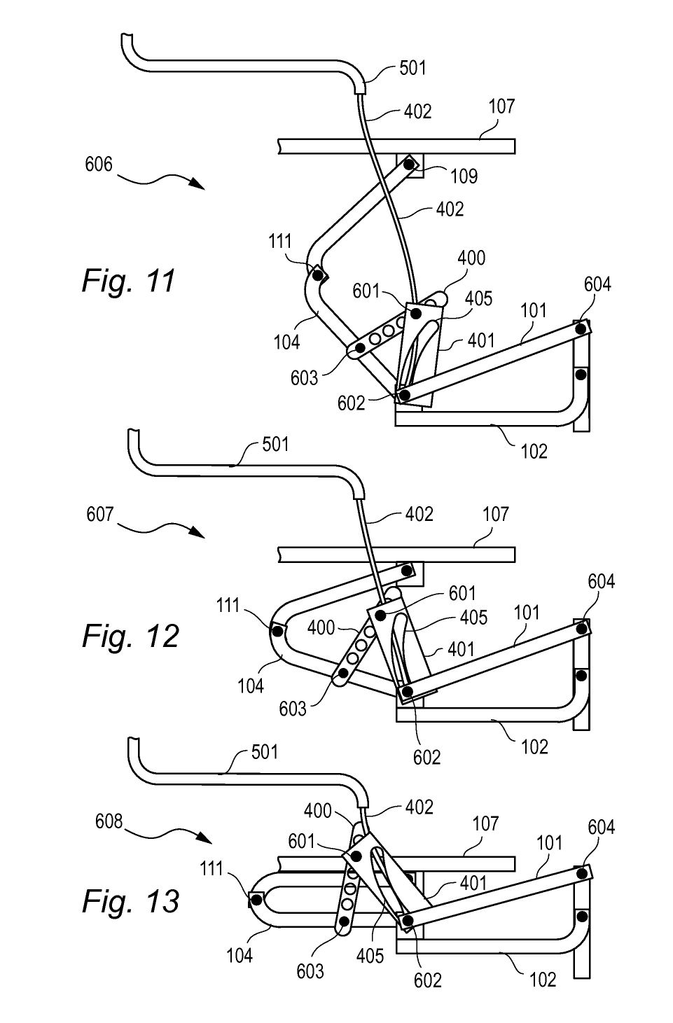

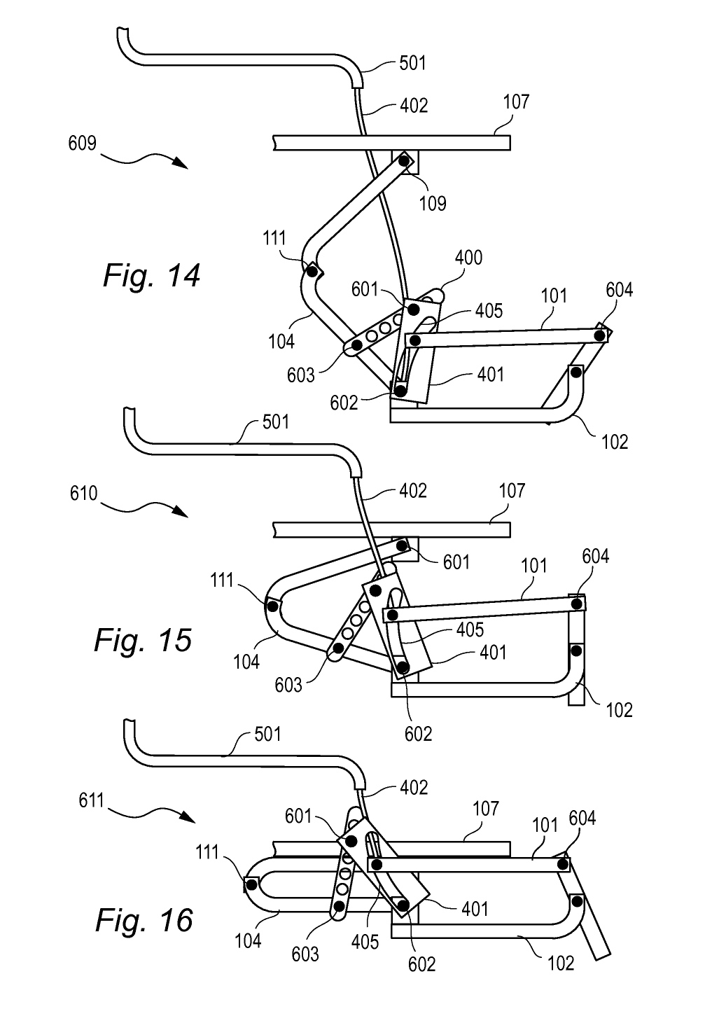

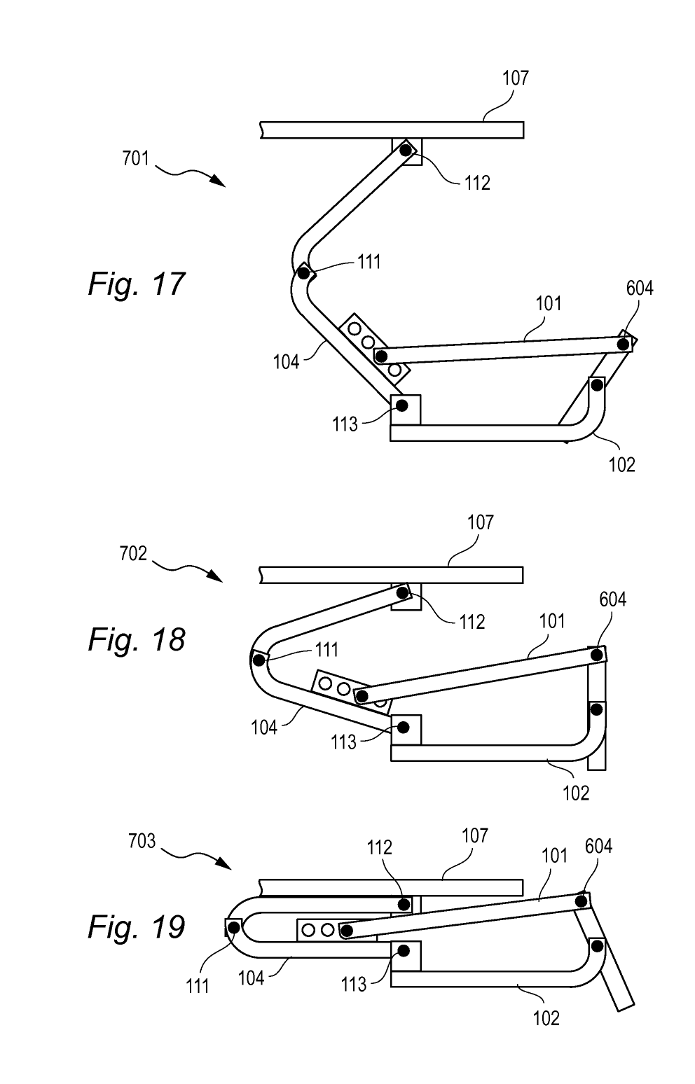

FIGS. 11-16 demonstrate how the camber-link arc element is positioned at various angles to the first articulating arm 104 by attaching it with the ride-height arm 400, in order to adjust the suspension system 100 to accommodate for varying ride-heights. By adjusting the angle between the camber-link arc element 401 and the first articulating arm 104, the suspension can be set to deliver optimal camber during turns under compression or droop, and zero camber when steering straight ahead, or steering off center but without compression or droop. FIGS. 11-13 show the rod 404 in a position at the bottom of the camber-link arc element 401. In each case, the steering knuckle 301 is set to zero camber at each specific ride height by positioning the camber-link arc element 401 at an angle to the first articulating arm 104, such that the rod 404 rests in the bottom of the channel of the camber-link arc element 401. FIGS. 14-16 show the resulting camber induced when the rod rises in the camber-link arc element at each of the ride heights demonstrate in FIGS. 11-13. FIG. 14 shows extreme positive camber under said conditions. FIG. 15 shows neutral camber under said conditions. FIG. 16 shows extreme negative camber under said conditions.

Various embodiments of the invention are described above in the Detailed Description. While these descriptions directly describe the above embodiments, it is understood that those skilled in the art may conceive modifications and/or variations to the specific embodiments described herein. Any such modifications or variations that fall within the purview of this description are intended to be included therein as well. Unless specifically noted, it is the intention of the inventor(s) that the words and phrases in the specification and claims be given the ordinary and accustomed meanings to those of ordinary skill in the applicable art(s).

The foregoing description of various embodiments of the present invention known to the applicant at the time of filing this application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the present invention in various embodiments and with various modifications as are suited to the particular use contemplated. Therefore, it is intended that the present invention not be limited to the particular embodiments disclosed for carrying out the present invention.

While particular embodiments of the present invention have been shown and described, it will be obvious to those skilled in the art that, based upon the teachings herein, changes and modifications may be made without departing from the present invention and its broader aspects. It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.).

What is claimed is:

1. An apparatus, comprising:
a first articulating arm comprising a first upper arm having an inferior end and a superior end and a first lower arm having an inferior end and a superior end, wherein the inferior end of the first upper arm is pivotally attached to the superior end of the first lower arm;
a second articulating arm comprising a second upper arm having an inferior end and a superior end and a second lower arm having an inferior end and a superior end, wherein the inferior end of the second upper arm is pivotally attached to the superior end of the second lower arm;
a wheel carrier pivotally attached to the inferior ends of the first and second lower arms;
a steering knuckle having a superior end and an inferior end, wherein the steering knuckle is attached to the wheel carrier; and
a camber-link arm having a superior end and an inferior end, wherein the camber-link arm is pivotally attached at its superior end to the superior end of the steering knuckle and is pivotally attached at its inferior end to the inferior end of the first lower arm.

2. The apparatus according to claim 1, wherein the inferior end of the camber-link arm and the inferior end of the first articulating arm are each independently configured to be attached to one another at any one of multiple points of attachment thereupon.

3. The apparatus according to claim 1, wherein the first and second articulating arms are each independently capable of articulating to form an angle of from about 0 degrees to about 180 degrees, as measured between the upper and lower arms of each articulating arm, respectively.

4. The apparatus according to claim 3, wherein the first and second articulating arms, when articulated to an angle of 180 degrees, are each configured in a plane substantially parallel to the vertical axis of the wheel carrier.

5. The apparatus according to claim 1, further comprising at least one removable dampener for controlling articulation of the first and second articulating arms.

6. The apparatus according to claim 5, wherein the at least one dampener is selected from the group consisting of a shock, a spring, a leaf spring, a coil, a torsion bar, a cantilever spring, a cantilever shock and combinations thereof.

7. The apparatus according to claim 1, further comprising an adjustable vertical limiter affixed substantially perpendicular to the wheel carrier for regulating suspension travel.

8. The apparatus according to claim 1, further comprising the chassis of a vehicle, pivotally attached to the superior ends of the first and second upper arms.

9. The apparatus according to claim 1, wherein the first articulating arm is attached to a first side of the wheel carrier and the second articulating arm is attached to an adjacent second side of the wheel carrier such that the apex of each of the articulating arms points in the opposite direction from the center of the wheel carrier when the articulating arms articulate to form an angle of less than 180 degrees.

10. An apparatus, comprising:
a first articulating arm comprising a first upper arm having an inferior end and a superior end and a first lower arm having an inferior end and a superior end;
a second articulating arm comprising a second upper arm having an inferior end and a superior end and a second lower arm having an inferior end and a superior end,
a wheel carrier attached to the first and second articulating arms,
a steering knuckle having a superior end and an inferior end, wherein the steering knuckle is attached to the wheel carrier,
a camber-link arm having an inferior end and a superior end, the superior end of the camber-link arm is pivotally attached to the superior end of the steering knuckle, wherein the inferior end of the first upper arm is pivotally attached to the superior end of the first lower arm forming a first articulating arm, the inferior end of the second upper arm is pivotally attached to the superior end of the second lower arm, forming a second articulating arm, and the inferior ends of the first and second lower arms are pivotally attached to the wheel carrier, and the superior end of the camber-link arm is pivotally attached to the superior end of the steering knuckle, and the inferior end of the camber-link arm is pivotally attached to the inferior end of the first articulating arm,
a steering mechanism,
means for the steering mechanism to mechanically communicate with the inferior end of the camber-link arm, whereby the camber-link arm is configured to follow an arc-shaped path upon actuation resulting from steering input, to thereby effectuate camber.

11. The apparatus according to claim 10, further comprising:
a camber-link-arc element, comprising first and second opposing sides, a back, a superior end and an inferior end, wherein the first and second sides each comprise an arc-shaped channel substantially along their respective vertical axes such that the arc-shaped channels are mirror images of one another, and the arc shape and direction of each channel is configured to approximate the path travelled by the inferior end of the camber-link arm when it is actuated, and wherein the back of the camber-link-arc element is affixed to the inferior end of the first articulating arm,
a rod extending across the camber-link arc element from the channel of the first side to the channel of the second side, wherein the rod is attached to the inferior end of the camber-link arm, and
means for the steering mechanism to mechanically communicate with the rod.

12. The apparatus of claim 11, wherein the means for the steering mechanism to mechanically communicate with the inferior end of the camber-link arm comprises:
a steering cam in communication with a rocker arm, the rocker arm comprising:
a superior end and an inferior end, the superior end of the rocker arm comprising a rolling element on a first side that interacts with the steering cam,
means for the rocker arm to pivot along a central axis perpendicular to its length upon interaction with the steering cam,
a hole through the inferior end of the rocker arm and oriented perpendicular to the axis of rotation of the rolling element,
a cable traversing the hole in the rocker arm, the cable having a superior end and an inferior end, the superior end anchored to the inferior end of the first side of the rocker arm such that it is prevented from entering the hole in the rocker arm through which the cable proceeds,
a cable housing with a superior end and an inferior end, the cable housing surrounding the portion of the cable extending beyond a second side of the inferior end of the rocker arm,
a brace located between the superior end of the cable housing and the second side of the inferior end of the rocker arm, the brace comprising a hole aligned with the hole in the inferior end of the rocker arm, through which the cable passes,
a plate with a superior side and an inferior side, the plate comprises a hole through which the cable passes, the superior side of the plate is in communication with the inferior end of the cable housing,
a spring with a superior end and an inferior end, the superior end of the spring in communication with the inferior side of the plate, the spring surrounding the portion of cable extending beyond the inferior side of the plate and the cable housing,
the rod comprising a hole in its short axis, the rod in communication with the inferior end of the spring and extending across the diameter of the inferior end of the spring, the cable passing through the hole in the rod from a superior aspect of the rod to the inferior aspect of the rod; the cable anchored to the inferior aspect of the rod, the rod attached to the inferior end of the camber-link arm, wherein the spring is substantially housed within the camber-link element, and the rod extends from the first arc-shaped channel across the inferior end of the spring and into the second arc-shaped channel, and the back of the camber-link-arc element is attached to the inferior end of the first articulating arm.

13. A method of inducing camber change using the apparatus of claim 11, comprising:
rotating the steering cam causing the cable to extract out of the cable housing, thereby causing the rod and the inferior end of the camber-link arm attached thereto to move along the arc-shaped channel, thereby inducing camber change.

14. The apparatus according to claim 11, further comprising means for attaching the camber-link-arc element at various angles to the inferior end of the first articulating arm.

15. The apparatus according to claim 14, wherein the means for attaching the camber-link arc element comprises a ride height arm with a first end and a second end, the first and second ends comprising holes, wherein the first end is attached to the superior end of the camber-link arc element and the second end is attached to the inferior end of the first articulating arm, and wherein the inferior of end of the camber-link arc element is attached to the first articulating arm at a position closer to the wheel carriage than the second end of the ride height arm.

16. The apparatus according to claim 11, further comprising a dampener.

17. The apparatus according to claim 16, wherein the dampener is selected from the group comprising of a shock, a spring, a leaf spring, a coil, a torsion bar, a cantilever shock, a cantilever spring and combinations thereof.

18. The apparatus according to claim 11, further comprising a chassis pivotally attached to the superior ends of the first and second arms.

19. The apparatus according to claim 11, further comprising an adjustable vertical limiter affixed substantially perpendicular to the wheel carrier for regulating suspension travel.
